(19) United States
(12) Patent Application Publication
(10) Pub. No.: US 2005/0082321 A1
(43) Pub. Date: Apr. 21, 2005

(54) Baton holster

(76) Inventors: Glenn E. Macierowski, Sparta, NJ (US); Eric J. Goleskie, Piscataway, NJ (US)

Correspondence Address: LITMAN LAW OFFICES, LTD., P.O. BOX 15035 CRYSTAL CITY STATION, ARLINGTON, VA, 22215, US

(21) Appl. No.: 10/688,893

(22) Filed: Oct. 21, 2003

(51) Int. Cl. B65D 25/52; A01K 97/04; A01K 97/06; A45F 5/00

(52) U.S. Cl. 224/197; 224/251

(57) ABSTRACT

A baton holder including baton holster including a central member with front, rear, right, and left sides, and an aperture defined in the front side; a belt loop device integrally engaged on the rear side of the central member configured to receive a belt to suspend the baton holster; a right support member integrally engaged on the right side of the central member; a left support member integrally engaged on the left side of the central member; and a universal baton support with a longitudinally extending member configured for removably being placed within the aperture on the front side of the central member, and for enabling the universal baton support to pivot 360° about a pivot point within the aperture.

### BACKGROUND OF THE INVENTION

1. Field of the Invention

The present invention generally relates to support devices and, more particularly, to a baton holster with a universal baton support.

2. Description of the Related Art

Law enforcement individuals, such as police officers, security personnel, or the like, commonly carry a number of items with them during their on duty rotations. One of the devices police officers often carry is a baton to offer them assistance during potentially threatening public encounters. Batons are normally carried in a baton holster. However, baton holsters typically provide no other function than supporting a particular baton. It would be desirable for law enforcement individuals to have access to a baton holster which provided them with additional functions other than the mere support of a baton, as well as a baton holster configured to hold any type of baton.

The related art is represented by the following references of interest.

U.S. Design Pat. No. 386,299, issued on Nov. 18, 1997 to Paul D. Starrett, shows an ornamental design of an expandable police baton holster. The Starrett '299 patent does not suggest a baton holster according to the claimed invention.

U.S. Design Pat. No. 386,612, issued on Nov. 25, 1997 to Paul D. Starrett, shows an ornamental design of a side handle police universal baton support. The Starrett '612 patent does not suggest a baton holster according to the claimed invention.

U.S. patent application Publication No. 2003/0052147 A1, published on Mar. 20, 2003 for Jerry Hughes et al., describes a rapid access technology carrier for holding items securely and, when engaged, the items are held at an angle where a police officer can grab and hold an item and place the item into action rapidly. The Hughes et al. application does not suggest a baton holster according to the claimed invention.

U.S. Pat. No. 4,588,116, issued on May 13, 1986 for Alan Litman, describes a holster for a chemical gas projector having an elongaated body with opposite first and second end portions and an intermediate portion therebetween. The Litman patent does not suggest a baton holster according to the claimed invention.

U.S. Pat. No. 4,662,552, issued on May 5, 1987 to James H. Uyehara, describes a holder for law enforcement baton that includes a belt mounted base to which a cylindrical sleeve, having a central axial aperture, is mounted so as to be pivotable in a vertical plane when the holder is mounted on the belt of a law enforcement officer. The Uyehara patent does not suggest a baton holster according to the claimed invention.

U.S. Pat. No. 5,076,478, issued on Dec. 31, 1991 to Henry M. Unger, describes a water holding device for a window washer. The Unger patent does not suggest a baton holster according to the claimed invention.

U.S. Pat. No. 5,353,977, issued on Oct. 11, 1994 to Frank P. Schiro, Jr. et al., describes an umbrella holster that provides hands free support of an umbrella held thereby, with the umbrella disposed to the front of the wearer of the holster to provide ready access for adjustment of the umbrella. The Schiro, Jr. et al. patent does not suggest a baton holster according to the claimed invention.

U.S. Pat. No. 5,551,610, issued on Sep. 3, 1996 to Norman E. Clifton, Jr., describes a holster for a truncheon, the holster being a unitary folded substantially sheet which is folded along a front portion and having meeting edges along a rear portion, and a transverse screw-and-nut combination connecting the two folded portions of the sheet to provide an adjustment to the clamping action of the holster to the truncheon. The Clifton, Jr. patent does not suggest a baton holster according to the claimed invention.

U.S. Pat. No. 5,562,238, issued on Oct. 8, 1996 to Roger A. White, describes a device for supporting items for use by a law enforcement officer. The White patent does not suggest a baton holster according to the claimed invention.

U.S. Patent No. 5,699,943, issued on Dec. 23, 1997 to Roger W. Schaefer et al., describes a belt-mounted flashlight holder that includes a belt loop sub-assembly and a cradle subassembly that are pivotally connected to permit the mounted flashlight to be rotated to any of several detented rotational positions. The Schaefer et al. patent does not suggest a baton holster according to the claimed invention.

U.S. Pat. No. 5,813,581, issued on Sep. 29, 1998 to Albert W. Hellweg, describes a pouch for a truncheon or baton having a body with an open upper end with a retaining flap to hold the truncheon in the pouch, and a lower end having at least one finger to enable the passage therethrough of the shaft of the truncheon when in the extended position, yet preventing unwanted extension of the shaft when the truncheon is placed in the pouch win the retracted position. The Hellweg patent does not suggest a baton holster according to the claimed invention.

U.S. Pat. No. 5,839,630, issued on Nov. 24, 1998 to Jacqueline M. Dunstan et al., describes a universal baton holster for a side-handled baton that includes a belt loop for wrapping around the user's belt and a pivotable baton holster attached to the belt loop by a swivel. The Dunstan et al. patent does not suggest a baton holster according to the claimed invention.

U.S. Pat. No. 6,010,045, issued on Jan. 4, 2000 to William H. Rogers et al., describes an adjustable carrier for a tool, weapon, or other holsterable object to be attached to any support, including a belt or body harness. The Rogers et al. patent does not suggest a baton holster according to the claimed invention.

U.S. Pat. No. 6,059,157 issued on May 9, 2000 to Kevin L. Parsons. et al., describes a baton carrier for expandable batons configured for receiving and stowing expandable batons when in either the retracted or expanded position. The Parsons et al. patent does not suggest a baton holster according to the claimed invention.

U.S. Pat. No. 6,145,654, issued on Nov. 14, 2000 to Kamran Loghman, describes a spray container storage and retrieval system including a holster for receiving a sleeve therein. The Loghman patent does not suggest a baton holster according to the claimed invention.

U.S. Pat. No. 6,386,726 B1, issued on May 14, 2002 to Glenn E. Macierowski et al., describes a hand-held personal defense/police baton that includes an elongated, telescoping main cylinder having an extendable first end and a second end including a rounded, shatterproof light that is secondarily useable for jabbing maneuvers, the, disclosure of which is incorporated herein by reference. The Macierowski et al. patent does not suggest a baton holster according to the claimed invention.

U.S. Pat. No. 6,497,349 B1, issued on Dec. 24, 2002 to Leonard C. Ramirez, describes a support device for an elongated weapon which is connectable to a belt. The Ramirez patent does not suggest a baton holster according to the claimed invention.

Great Britain Patent Application Publication No. GB 2 256 264 A, published on Dec. 2, 1992, describes a holster for a guard baton with a crosshandle. The Great Britain '264 application does not suggest a baton holster according to the claimed invention.

Great Britain Patent Application Publication No. GB 2 284 443 A, published on Jun. 7, 1995, describes a secure holder for handcuffs or a baton. The Great Britain '443 application does not suggest a baton holster according to the claimed invention.

France Patent Application Publication No. 2,812,923 A1, published on Feb. 15, 2002, describes a device including a rigid rod able to translate and rotate one end of which penetrates a recess of a piston. The France '923 application does not suggest a baton holster according to the claimed invention.

None of the above inventions and patents, taken either singly or in combination, is seen to describe the instant invention as claimed. Thus a baton holster solving the aforementioned problems is desired.

### SUMMARY OF THE INVENTION

The present invention is a baton holster. The baton holster includes a central member with front, rear, left, and right sides. Integrally engaged on the rear side of the central member is a belted loop device configured to receive a belt to suspend the baton holster. Integrally engaged on the right side of the central member is a right support member. Integrally engaged on the left side of the central member is a left support member.

An aperture is defined in the front side of the central member and is configured for removably receiving a universal baton support. The aperture enables the universal baton support, when attached to the central member, to pivot 360° about a pivot point within the aperture. The central member also includes arcuate recesses defined within the front side of the central member. The arcuate recesses are configured to enable the universal baton support to pivotally rotate about the pivot point and remain in position in incremental angular positions unless a force greater than a predetermined amount of force is applied to the universal baton support to cause it to move about the recesses.

Accordingly, it is a principal aspect of the invention to a provide a baton holster including a central member with front, rear, right, and left sides, and an aperture defined in the front side; a belt loop device integrally engaged on the rear side of the central member configured to receive a belt to suspend the baton holster; a right support member integrally engaged on the right side of the Central member; a left support member integrally engaged on the left side of the central member; and a universal baton support with a longitudinally extending member configured for removably being placed within the aperture on the front-side of the central member, and for enabling the universal baton support to pivot 360° about a pivot point within the aperture.

It is another aspect of the invention to provide a provide a baton holster including a central member with front, rear, right, and left sides, and an aperture defined in the front side; a belt loop device integrally engaged on the rear side of the central member configured to receive a belt to suspend the baton holster; a right support member integrally engaged on the right side of the central member; a left support member integrally engaged on the left side of the central member; and a universal baton support with a longitudinally extending member configured for removably being placed within the aperture on the front side of the central member, and for enabling the universal baton support to pivot 360° about a pivot point within the aperture; and arcuate recesses defined within the front side of the central member that are configured to enable the universal baton support to pivotally rotate 360° about a pivot point and remain in position in incremental angular positions unless a force grater than a predetermined amount of force is applied to the universal baton support to cause the universal baton support to move about the recesses.

It is a further aspect of the invention to provide a baton holster in combination with a baton, the combination including: a central member with front, rear, right, and left sides, and an aperture defined in the front side of the central member, a belt loop device integrally engaged on the rear side of the central member configured to receive a belt to suspend the baton holster; a right support member integrally engaged on the right side of the central member; a left support member integrally engaged on the left side of the central member; and a universal baton support with a longitudinally extending member configured for removably being placed within the aperture on the front side of the central member, and for enabling the universal baton support to pivot 360° about a pivot point within the aperture; and a baton including an elongated, hollow, telescoping, horizontal main cylinder having an extendable first end and a second end comprising a hard, rounded fixture for high-impact police maneuvers.

Still another aspect of the invention is to provide a baton holster in combination with a baton, the baton holster including a central member with front, rear, right, and left sides, and an aperture defined in the front side of the central member; a belt loop device integrally engaged on the rear side of the central member configured to receive a belt to suspend the baton holster; a right support member integrally engaged on the right side of the central member; a left support member integrally engaged on the left side of the central member; a locking tab on the front side of the central member; a universal baton support with a longitudinally extending member configured for removably being placed within the aperture on the front side of the central member, and for enabling the universal baton support to pivot 360° about a pivot point within the aperture; and a baton including an elongated, hollow, telescoping, horizontal main cylinder having an extendable first end and a second end with hard, rounded fixture for high-impact police maneuvers, wherein the cylindrical apertures are configured for receiving a perpendicularly extending handle from a baton that has been inserted in the universal baton support, and enabling the top of the universal baton support to expand and retract in a clasping manner so as to enable a user to insert and remove a baton from the universal baton support with a predetermined amount of force; and the locking tab and the longitudinally extending member are on diametrically opposed portions of the side of the universal baton support that are each offset about 90° from the cylindrical apertures proximate the top end of the universal baton support.

It is an aspect of the invention to provide improved elements and arrangements thereof for the purposes described which is inexpensive, dependable and fully effective in accomplishing its intended purposes.

These and other aspects of the present invention will, become readily apparent upon further review of the following specification and drawings.

### BRIEF DESCRIPTION OF THE DRAWINGS

FIG. 1 is an environmental, perspective view of law enforcement individual walking with a baton holster attached to his belt according to the present invention.

FIG. 2A is a front perspective exploded view of the baton holster shown in FIG. 1.

FIG. 2B is a rear perspective exploded view of the baton holster shown in FIG. 1.

FIG. 3 is a front view of the baton holster shown in FIG. 1.

FIG. 4 is a rear view of the baton holster shown in FIG. 1.

FIG. 5 is a right side view of the baton holster shown in FIG. 1.

FIG. 6 is a left side view of the baton holster shown in FIG. 1.

FIG. 7 is a top view of the baton holster shown in FIG. 1.

FIG. 8 is a bottom view of the baton holster shown in FIG. 1.

FIG. 9 is a front perspective view of an expandable baton according to the prior art.

FIG. 10 is a cross-sectional view of the expandable baton shown in FIG. 9.

Similar reference characters denote corresponding features consistently throughout the attached drawings.

### DETAILED DESCRIPTION OF THE PREFERRED EMBODIMENTS

The present invention is a baton holster. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

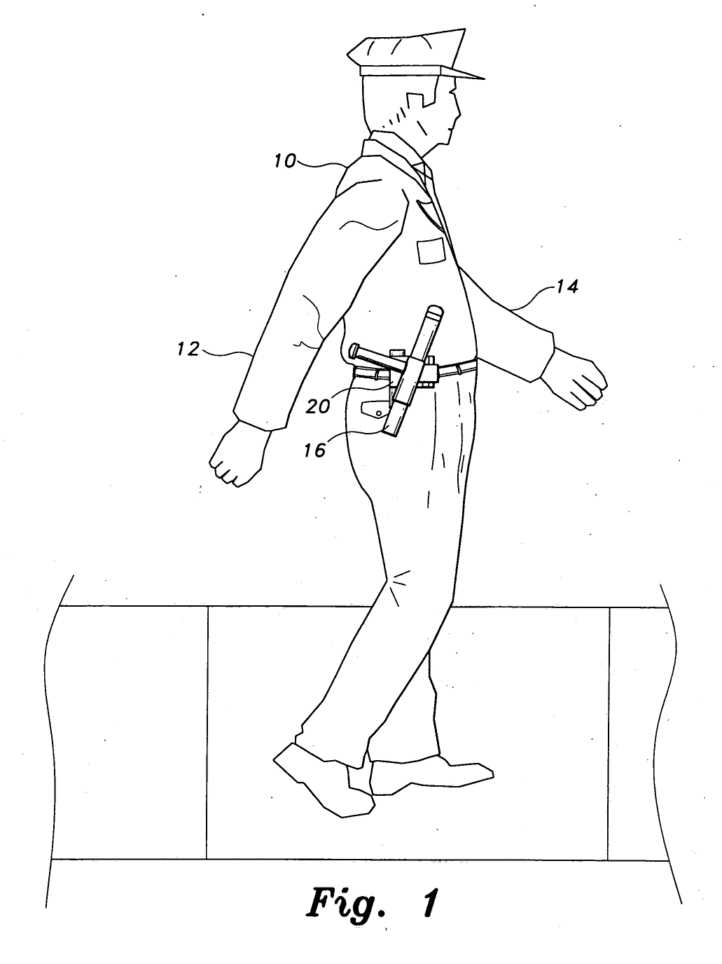

Referring to the drawings, FIG. 1 shows a law enforcement individual 10, such as a police officer, a security guard, or the like, walking along a pathway. The law enforcement individual 10 has right and left arms 12 and 14, respectively and is carrying an adjustable baton 16 in a baton holster 20. Obviously, any individual is able to wear and/or carry a baton holster 20 according to the invention.

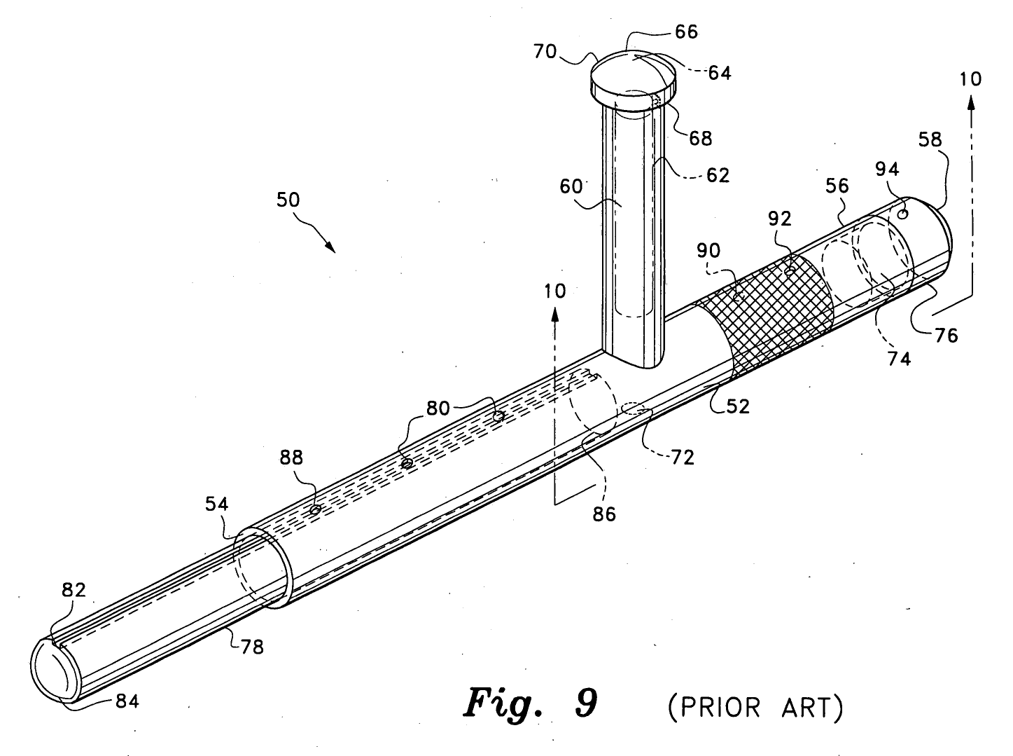

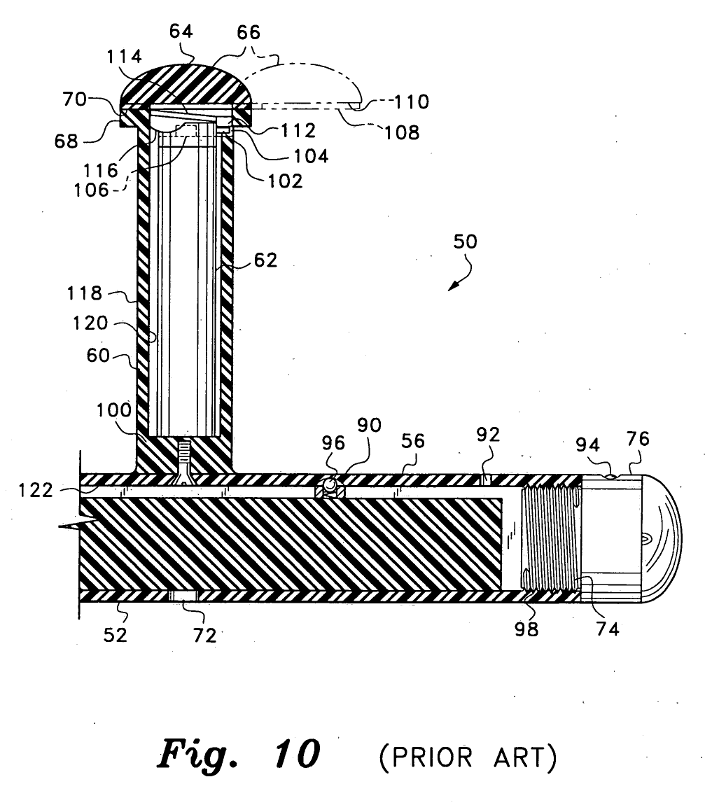

The baton holster 20 is configured to carry any type of baton, such as an adjustable baton, a non-adjustable baton, a straight baton, a baton with a handle, or the like. The adjustable baton 16 is shown in more detail in FIGS. 9 and 10 (see U.S. Pat. No. 6,386,726 B1). The baton holster 20 is preferably formed of a durable material such as polycarbonate, plastic, metal, leather, or the like.

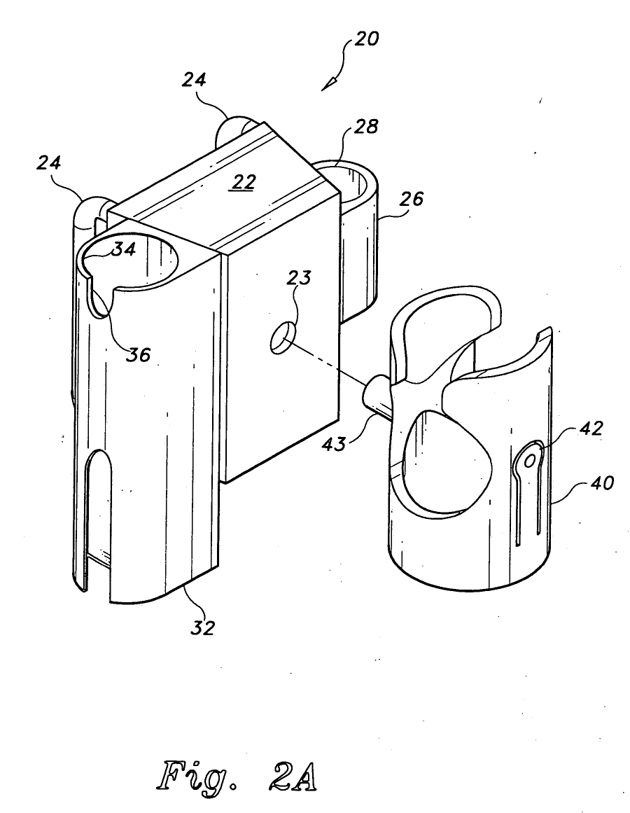

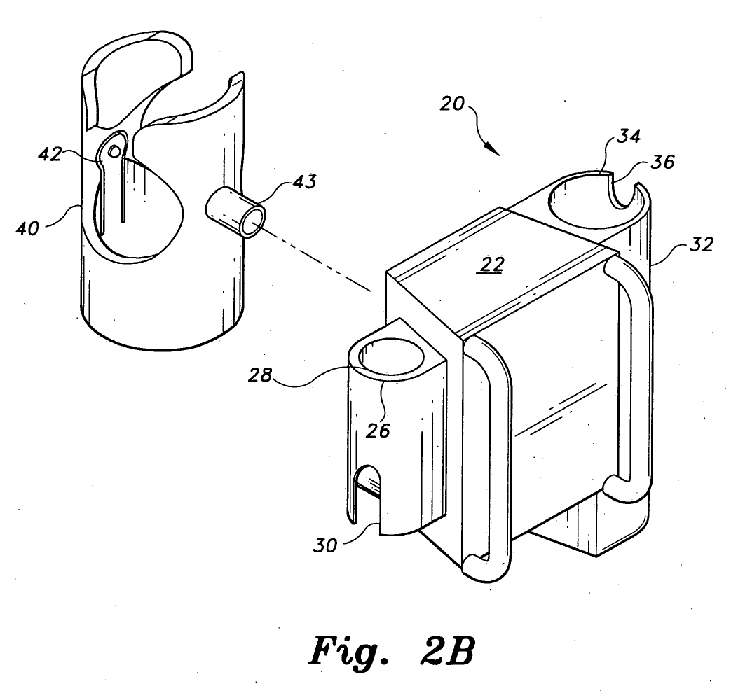

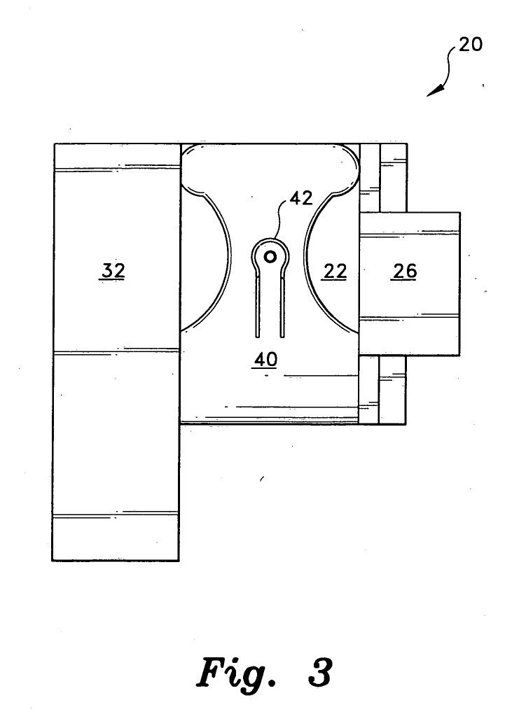

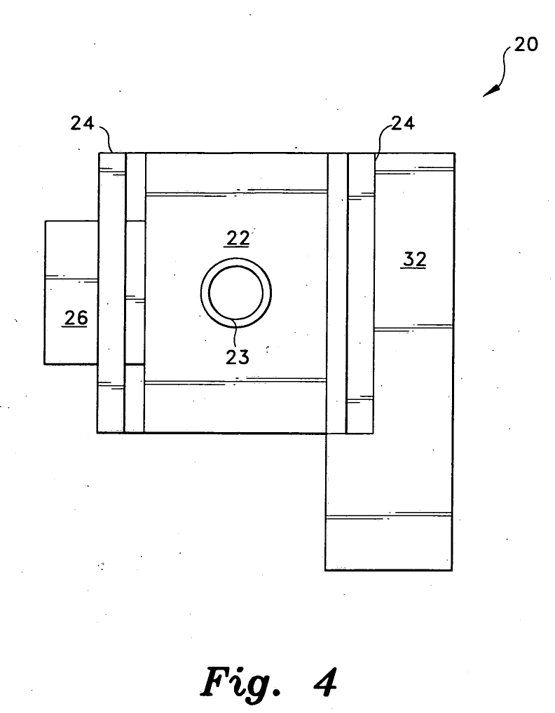

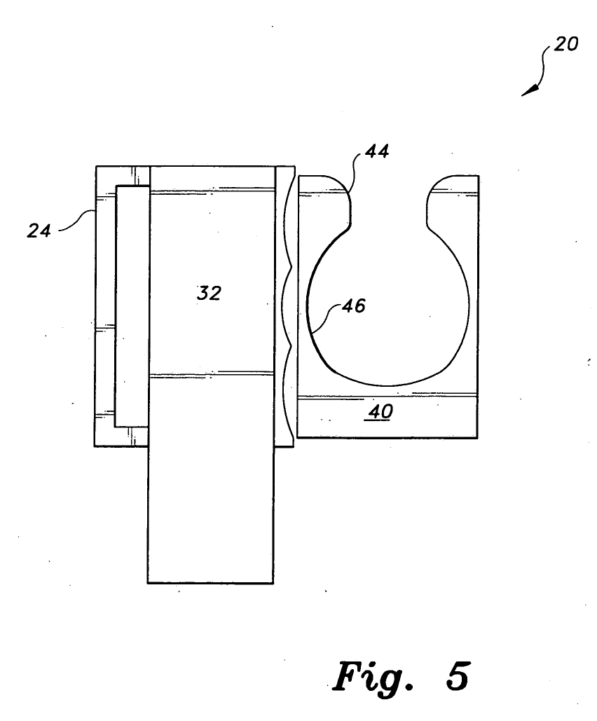

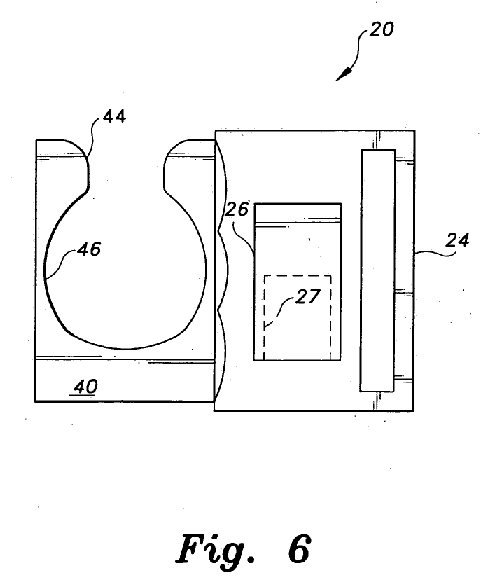

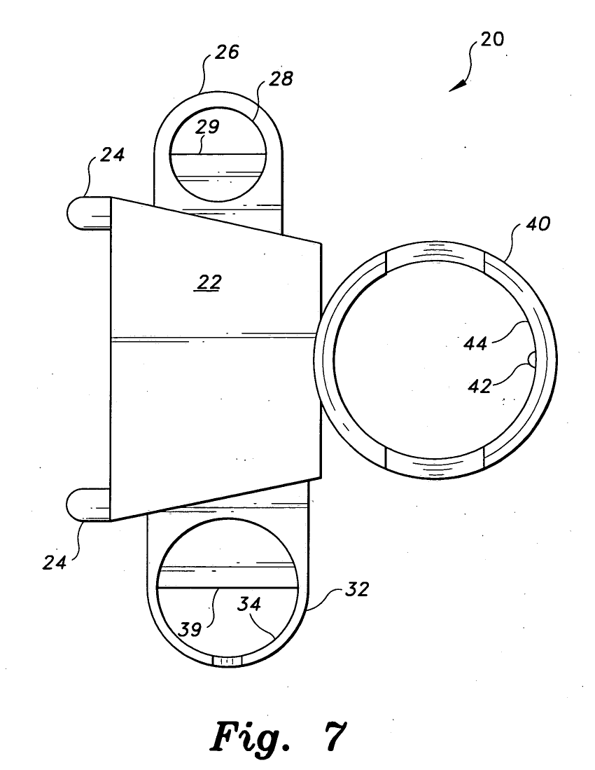

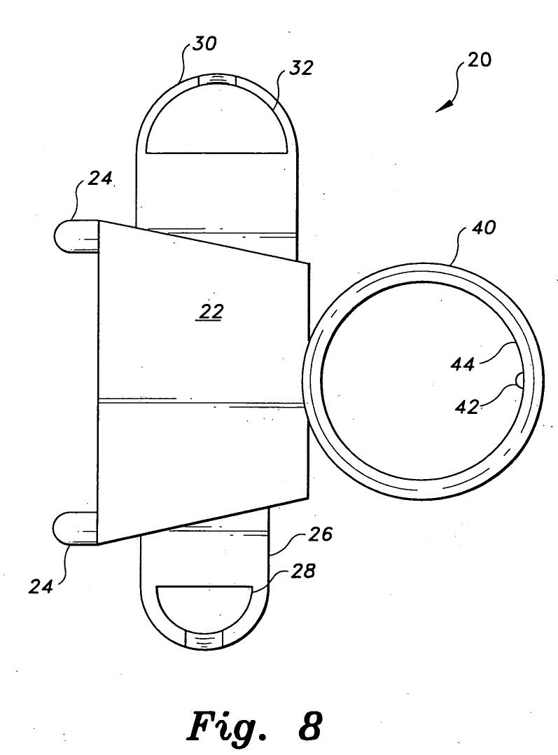

As shown in FIGS. 2A-8, the baton holster 20 includes a central member 22 with front, rear, left, and right sides. Integrally engaged on the rear side of the central member 22 is a belted loop device configured to receive a belt to suspend the baton holster. While the belt loop device is shown in the form of two belt loops 24, the belt loop device may be configured with any number of belt loops. Integrally engaged on the right side of the central member 22 is a right support member 26. Integrally engaged on the left side of the central member 22 is a left support member 32.

An aperture 23 is defined in the front side of the central member 22 and is configured for removably receiving a universal baton support 40. The aperture 23 enables the universal baton support 40, when attached to the central member 22, to pivot 3600 about a pivot point within the aperture 23. The central member 22 also includes arcuate recesses defined within the front side of the central member 22. The arcuate recesses are configured to enable the universal baton support 40 to pivotally rotate about the pivot point and remain in position in incremental angular positions, such as 45° or the like, unless a force greater than a predetermined amount of force is applied to the universal baton support 40 to cause it to move about the recesses.

The right support member 26 includes a top end and a bottom 10 end. The right support member 26 extends for a predetermined length from the top and bottom ends. A cylindrical opening 28 having a predetermined diameter extends from the top to bottom ends of the right support member 26 to form a support pocket for an external object. Preferably, the support pocket of the right support member 26 is configured for receiving a battery pack or similarly configured type of power source. The right support member 26 also includes a flat ledge 29 at the bottom end of the right support member 26 that extends away from the central member 22 about 50-75% of the diameter of the cylindrical opening 28.

The right support member 26 also includes a longitudinally extending notch 30 that extends from the bottom end of the right support member 26 for a predetermined length towards the top end of the right support member 26. The longitudinally extending notch 30 is preferably configured to enable an individual to pass a finger therethrough to push upwards the bottom of an object contained in the support pocket so the top of the object extends above the top end of the cylindrical opening 28. The notch 30 facilitates the ability of a user of the baton holster 20 to easily and readily remove an object contained in the support pocket of the right support member 26.

The left support member 32 includes a top end and a bottom end. The left support member 32 extends for a predetermined length from the top and bottom ends. A cylindrical opening 34 having a predetermined diameter extends from the top to bottom ends of the left support member 32 to form a support pocket for an external object. Preferably, the support pocket of the left support member 32 is configured for receiving a canister of pepper spray or similarly configured item. The left support member 32 also includes a flat ledge 39 at the bottom end of the support member that extends away from the central member 22 about 50-75% of the diameter of the cylindrical opening 32.

The left support member 32 also includes a longitudinally extending notch that extends from the bottom end of the left support member 32 for a predetermined length towards the top end of the left support member 32. The longitudinally extending notch is preferably configured to enable an individual to pass a finger therethrough to push upwards the bottom of an object contained in the support pocket so the top of the object extends above the top end of the cylindrical opening 34. The notch facilitates the ability of a user of the baton holster 20 to easily and readily remove an object contained in the support pocket of the left support member 32.

The universal baton support 40 includes a top end, a bottom end, and a side. The universal baton support 40 extends for a predetermined length from the top and bottom ends. A cylindrical opening having a predetermined diameter extends from the top to bottom ends of the universal baton support to form a support sheath for an external object. Cylindrical apertures proximate the top end of the universal baton support 40 are defined in diametrically opposed portions of the side of the universal baton support. The cylindrical apertures are configured for receiving a perpendicularly extending handle from a baton that has been inserted in the universal baton support 40. The cylindrical apertures near the top of the universal baton support 40 enable the top of the universal baton support 40 to expand and retract in a clasping manner. The top of the universal baton support 40 is configured to enable a user to insert and remove a baton from the universal baton support 40 with a predetermined amount of force.

The universal baton support 40 also includes a locking tab 42 and a longitudinally extending member 43 on diametrically opposed portions of the side of the universal baton support 40 that are each offset about 90° from the cylindrical apertures proximate the top end of the universal baton support 40. The locking tab 42 is configured to secure a straight baton placed within the universal baton support, and the longitudinal member 43 is configured to be removably placed within the aperture on the front side of the central member, and to enable the universal baton support 40 to pivot 360° about a pivot point within the aperture.

As discussed above, the universal baton support 40 may be pivotally attached to the central member 22 via the longitudinal member 43 so as to enable the universal baton support 40 to pivotally rotate 360° about a pivot point and remain in position in incremental angular positions, such as 45° or the like, unless a force grater than a predetermined amount of force is applied to the universal baton support 40 to cause it to move about the recesses of the central member 22.

FIGS. 9 and 10 illustrate an adjustable baton 50 that may used in combination with the baton holster 20. The adjustable baton 50 includes an elongated; telescoping, horizontal main cylinder 78 having an extendable first end 84, and a second end 76 including a fixture that is preferably a shatter-proof light 58. A mushroom-shaped side handle 60 extends transversely from main cylinder 84 proximate the second end 76. The side handle 60 contains a pressurized canister 62 having a fluid projecting nozzle 68. A canister push button 106 effectuates fluid communication between canister 62 and nozzle 68. Canister 62 preferably contains a chemical eye irritant, such as Mace®. Each end 54, 56 of main cylinder 52, as well as side handle 60, may be used for standard jabbing maneuvers employed by law enforcement and/or in self defense. Each of these three baton extremities also has at least a dual function, as further described.

As best shown in FIG. 10, side handle 60 includes a mounting base 100 adjacent main cylinder 56. Preferably, side handle 60 is affixed to main cylinder 56 with an internal flat head bolt that is fastened to an inside wall 122 of main cylinder 56 and that extends through mounting base 100 of side handle 60. Access to the bolt is gained by extending extension member 78 through cylinder 56 so that the proximal end 86 of extension member 78 clears the shaft of the side handle 60. A tool can then be inserted through opening 72 to reach the head of the bolt. The side handle 60 could also easily be welded to the cylinder 56.

A solid, semi-spherical closure top 64, opposite base 100, resembles the cap of a mushroom. Closure top 64 has a curved upper surface 66, a flat, horizontal lower surface 110, and a perimeter edge 70 connecting lower surface 110 to the upper surface 66. Closure top 64 is capable of sliding forward toward second end 56 and in a reverse direction toward first end 54 in a horizontal plane across the top of collar 68.

Side handle stem 60 connects-collar 68 to main cylinder 52. Stem 60, has formed therein a cylindrical chamber 120 which houses canister 62. A dispensing port is disposed beneath and adjacent to collar 68. The dispensing port comprises a small hole 104 through a wall portion of chamber 120, facing second end 56 of main cylinder 56 such that nozzle 102 dispenses the Mace®, or other chemical irritant, in an essentially horizontal stream, essentially parallel to the longitudinal axis of main cylinder 56.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A baton holster comprising:
a central member with front, rear, right, and left sides, and an aperture defined in the front side;
a belt loop device integrally engaged on the rear side of the central member configured to receive a belt to suspend the baton holster;
a right support member integrally engaged on the right side of the central member;
a left support member integrally engaged on the left side of the central member; and
a universal baton support with a longitudinally extending member configured for removably being placed within the aperture on the front side of the central member, and for enabling the universal baton support to pivot 360° about a pivot point within is the aperture.

2. The baton holster according to claim 1, wherein the central member further comprises arcuate recesses defined within the front side of the central member that are configured to enable the universal baton support to pivotally rotate 360° about a pivot point and remain in position in incremental angular positions unless a force grater than a predetermined amount of force is applied to the universal baton support to cause the universal baton support to move about the recesses.

3. The baton holster according to claim 1, wherein said right support member further comprises:
a top end;
a bottom end, the support member extending for a predetermined length from the top and bottom ends of the right support member;
a cylindrical opening having a predetermined diameter that extends from the top to bottom ends of the right support member to form a support pocket for an external object;
a flat ledge at the bottom end of the right support member that extends away from the central member.

4. The baton holster according to claim 3, wherein said right support member further comprises a longitudinally extending notch that extends from the bottom end of the support member for a predetermined length towards the top end of the right support member.

5. The baton holster according to claim 1, wherein said left support member further comprises:
a top end,
a bottom end, the support member extending for a predetermined length from the top and bottom ends of the left support member;
a cylindrical opening having a predetermined diameter that extends from the top to bottom ends of the left support member to form a support pocket for an external object;
a flat ledge at the bottom end of the left support member that extends away from the central member.

6. The baton holster according to claim 1, wherein said left support member further comprises a longitudinally extending notch that extends from the bottom end of the left support member for a predetermined length towards the top end of the left support member.

7. The baton holster according to claim 1, wherein said universal baton support comprises:
a top end;
a bottom end;
a side, the universal baton support extending for a predetermined length from the top and bottom ends;
a cylindrical opening having a predetermined diameter that extends from the top to bottom ends of the universal baton support to form a support sheath for an external object;
cylindrical apertures proximate the top end of the universal baton support being defined in diametrically opposed portions of the side of the universal baton support; and
a locking tab on a side of the universal baton support,
wherein the cylindrical apertures are configured for receiving a perpendicularly extending handle from a baton that has been inserted in the universal baton support, and enabling the top of the universal baton support to expand and retract in a clasping manner so as to enable a user to insert and remove a baton from the universal baton support with a predetermined amount of force; and the locking tab and longitudinally extending member are on diametrically opposed portions of the side of the universal baton support that are each offset about 90° from the cylindrical apertures proximate the top end of the universal baton support.

8. A baton holster in combination with a baton, said combination comprising:
a baton holster comprising:
a central member with front, rear, right, and left sides, and an aperture defined in the front side of the central member;
a belt loop device integrally engaged on the rear side of the central member configured to receive a belt to suspend the baton holster;
a right support member integrally engaged on the right side of the central member;
a left support member integrally engaged on the left side of the central member; and
a universal baton support with a longitudinally extending member configured for removably being placed within the aperture on the front side of the central member, and for enabling the universal baton support to pivot 360° about a pivot point within the aperture; and
a baton comprising: and
an elongated, hollow, telescoping, horizontal main cylinder having an extendable first end and a second end comprising a hard, rounded fixture for high-impact police maneuvers.

9. The combination according to claim 8, further comprising arcuate recesses defined within the front side of the central member that are configured to enable the universal baton support to pivotally rotate 360° about a pivot point and remain in position in incremental angular positions unless a force grater than a predetermined amount of force is applied to the universal baton support to cause the universal baton support to move about the recesses.

10. The combination according to claim 8, wherein said right support member further comprises:
a top end;
a bottom end, the support member extending for a predetermined length from the top and bottom ends of the right support member;
a cylindrical opening having a predetermined diameter that extends from the top to bottom ends of the right support member to form a support pocket for an external object;
a flat ledge at the bottom end of the right support member that extends away from the central member.

11. The combination according to claim 8, wherein said right support member further comprises a longitudinally extending notch that extends from the bottom end of the support member for a predetermined length towards the top end of the right support member.

12. The combination according to claim 8, wherein said left support member further comprises:
a top end;
a bottom end, the support member extending for a predetermined length from the top and bottom ends of the left support member;
a cylindrical opening having a predetermined diameter that extends from the top to bottom ends of the left support member to form a support pocket for an external object;
a flat ledge at the bottom end of the left support member that extends away from the central member.

13. The combination according to claim 8, wherein said left support member further comprises a longitudinally extending notch that extends from the bottom end of the left support member for a predetermined length towards the top end of the left support member.

14. The combination according to claim 8, wherein said universal baton support comprises:
a top end;
a bottom end;
a side, the universal baton support extending for a predetermined length from the top and bottom ends;
a cylindrical opening having a predetermined diameter that extends from the top to bottom ends of the universal baton support to form a support sheath for an external object;
cylindrical apertures proximate the top end of the universal baton support being defined in diametrically opposed portions of the side of the universal baton support; and
a locking tab on a side of the universal baton support,
wherein the cylindrical apertures are configured for receiving a perpendicularly extending handle from a baton that has been inserted in the universal baton support, and enabling the top of the universal baton support to expand and retract in a clasping manner so as to enable a user to insert and remove a baton from the universal baton support with a predetermined amount of force; and the locking tab and the longitudinally extending member are on diametrically opposed portions of the side of the universal baton support that are each offset about 90° from the cylindrical apertures proximate the top end of the universal baton support.
